(19) United States
(12) Patent Application Publication
(10) Pub. No.: US 2016/0379668 A1
(43) Pub. Date: Dec. 29, 2016

(54) STRESS REDUCTION AND RESILIENCY TRAINING TOOL

(71) Applicant: THINK'n Corp., Burlington (CA)

(72) Inventors: LESLEY GREIG, Stoney Creek (CA); NICOLE KARKI-NIEJADLIK, Burlington (CA); GIOVANNA VOLO, Hamilton (CA)

(21) Appl. No.: 14/748,555

(22) Filed: Jun. 24, 2015

(51) Int. Cl. G10L 25/66; G10L 15/07; G10L 21/10

(52) U.S. Cl. CPC G10L 25/66; G10L 21/10; G10L 15/07; G10L 2015/225

(57) ABSTRACT

A computer-implemented method, a computing device, and a computer program product (such as a mobile application) are described that implement a CBT and mindfulness training tool. The method can be embodied in the product and executed by the computing device. The method can include receiving first input from a user that represents a description of cognitive conditions of the user. The first input can include factual information and at least one conclusion drawn by the user from the factual information. The method can also include receiving a second input from the user that includes factual information inconsistent with the at least one conclusion. The method can also include determining impugning material based on the factual information and the at least one conclusion. The impugning material can be configured to be consistent with the factual information of the first input and the factual information of the second input. The impugning material can be output to the user.

### BACKGROUND

1. Field

The present disclosure relates to electronic communication tools and, more particularly, to an improved tool for training a user to apply the technique of stress reduction and resiliency.

2. Description of Related Prior Art

U.S. Pub. No. 2002/0107707 discloses a SYSTEM AND METHOD FOR PROVIDING PERSONALIZED HEALTH INTERVENTIONS OVER A COMPUTER NETWORK. A user interface is provided to a client over the computer network, and health issue information is received back from the client. Personalized health interventions directed to the client are determined based on the received information. Selected audio and/or visual health interventions are delivered to the client. The selected interventions are presented to the client in the form of a daily health intervention schedule listing interventions by time. The schedule includes links to several health interventions which can be accessed through a client computer screens. The schedule may be linked with local scheduling applications.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method is described. The method can include receiving, at a computing device having one or more processors, a first input from a user. The first input can include at least one of text and one or more speech sounds representative of one or more words. The first input can represent a description of cognitive conditions of the user. The cognitive conditions can correspond to stress experienced by the user. The first input can include factual information and at least one conclusion drawn by the user from the factual information. The method can also include receiving, at the computing device, a second input from the user after receiving the first input. The second input can include at least one of text and one or more speech sounds representative of one or more words. The second input can include factual information inconsistent with the at least one conclusion. The method can also include determining, at the computing device, impugning material based on the factual information and the at least one conclusion of the first input. The impugning material can include at least one of audio and visual information configured to contradict the at least one conclusion. The impugning material can be configured to be consistent with the factual information of the first input and the factual information of the second input. The method can also include outputting, at the computing device, the impugning material to the user.

In some embodiments, the outputting can be further defined as outputting, at the computing device, the impugning material to the user a plurality of different formats. In some embodiments, the outputting can be further defined as outputting, at the computing device, the impugning material to the user in a pulsing pattern. The factual information of the first input can include physical symptoms of the user. The computer-implemented method can also include determining, at the computing device, training material based on the physical symptoms. The training material can include at least one of audio and visual information configured to reduce the physical symptoms of the user. The computer-implemented method can also include outputting, at the computing device, the training material to the user. The computer-implemented method can also include outputting, at the computing device, a series of questions to the user. The series of questions can be configured to prompt the user to input conclusions alternative to the at least one conclusion and alternative to the impugning material. The computer-implemented method can also include outputting, at the computing device, a display of a probability pie or a continuum tool to the user. The probability pie or continuum tool can indicate the probabilities of at least the at least one conclusion and alternative to the impugning material.

A computing device is described. The computing device can include one or more processors. The computing device can also include a non-transitory, computer readable medium storing instructions. The instructions, when executed by the one or more processors, can cause the computing device to perform the operation of receiving a first input from a user. The first input can include at least one of text and one or more speech sounds representative of one or more words. The first input can represent a description of cognitive conditions of the user. The cognitive conditions can correspond to stress experienced by the user. The first input can include factual information and at least one conclusion drawn by the user from the factual information. The instructions, when executed by the one or more processors, can also cause the computing device to perform the operation of receiving, at the computing device, a second input from the user after receiving the first input. The second input can include at least one of text and one or more speech sounds representative of one or more words. The second input can include factual information inconsistent with the at least one conclusion. The instructions, when executed by the one or more processors, can also cause the computing device to perform the operation of determining, at the computing device, impugning material based on the factual information and the at least one conclusion of the first input. The impugning material can include at least one of audio and visual information configured to contradict the at least one conclusion. The impugning material can be configured to be consistent with the factual information of the first input and the factual information of the second input. The instructions, when executed by the one or more processors, can also cause the computing device to perform the operation of outputting, at the computing device, the impugning material to the user.

In some variations, the outputting can be further defined as outputting, at the computing device, the impugning material to the user a plurality of different formats. In some embodiments, the outputting can be further defined as outputting, at the computing device, the impugning material to the user in a pulsing pattern. The factual information of the first input can include physical symptoms of the user. The instructions, when executed by the one or more processors, can also cause the computing device to perform the operation of determining, at the computing device, training material based on the physical symptoms. The training material can include at least one of audio and visual information configured to reduce the physical symptoms of the user. The instructions, when executed by the one or more processors, can also cause the computing device to perform the operation of outputting the training material to the user. The instructions, when executed by the one or more processors, can also cause the computing device to perform the operation of outputting, at the computing device, a series of questions to the user. The series of questions can be configured to prompt the user to input conclusions alternative to the at least one conclusion and alternative to the impugning material. The instructions, when executed by the one or more processors, can also cause the computing device to perform the operation of a display of a probability pie or continuum tool to the user. The probability pie or continuum tool can indicate the probabilities of at least the at least one conclusion and alternative to the impugning material.

A computer program product (such as a mobile application) comprising a non-transitory, computer readable storage medium having computer-readable instructions embodied in the medium is described. The instructions, when executed by a computing device having one or more processors, can cause the computing device to perform operations. The operations can include receiving a first input from a user. The first input can include at least one of text and one or more speech sounds representative of one or more words. The first input can represent a description of cognitive conditions of the user. The cognitive conditions can correspond to stress experienced by the user. The first input can include factual information and at least one conclusion drawn by the user from the factual information. The operations can also include receiving, at the computing device, a second input from the user after receiving the first input. The second input can include at least one of text and one or more speech sounds representative of one or more words. The second input can include factual information inconsistent with the at least one conclusion. The operations can also include determining, at the computing device, impugning material based on the factual information and the at least one conclusion of the first input. The impugning material can include at least one of audio and visual information configured to contradict the at least one conclusion. The impugning material can be configured to be consistent with the factual information of the first input and the factual information of the second input. The operations can also include outputting, at the computing device, the impugning material to the user.

In some variations, the outputting can be further defined as outputting, at the computing device, the impugning material to the user a plurality of different formats. In some embodiments, the outputting can be further defined as outputting, at the computing device, the impugning material to the user in a pulsing pattern. The factual information of the first input can include physical symptoms of the user. The operations can also include determining, at the computing device, training material based on the physical symptoms. The training material can include at least one of audio and visual information configured to reduce the physical symptoms of the user. The operations can also include outputting the training material to the user. The operations can also include outputting, at the computing device, a series of questions to the user. The series of questions can be configured to prompt the user to input conclusions alternative to the at least one conclusion and alternative to the impugning material.

### BRIEF DESCRIPTION OF THE DRAWINGS

The detailed description set forth below references the following drawings:

FIG. 1 is a diagram of a computing system including an example computing device according to some implementations of the present disclosure;

FIG. 2 is a functional block diagram of the example computing device of FIG. 1;

FIG. 3 is a view of a display of the example computing device of FIG. 1 displaying a user interface of a stress reduction and resiliency training tool according to some implementations of the present disclosure;

FIG. 4 is a view of a display of the example computing device of FIG. 1 displaying a user interface of a stress reduction and resiliency training tool according to other implementations of the present disclosure;

FIG. 5 is a view of a display of the example computing device of FIG. 1 displaying a user interface of a stress reduction and resiliency training tool according to other implementations of the present disclosure;

FIG. 6 is a view of a display of the example computing device of FIG. 1 displaying a user interface of a stress reduction and resiliency training tool according to other implementations of the present disclosure; and

FIG. 7 is a flow diagram of an example method for stress reduction and resiliency training.

### DETAILED DESCRIPTION

As set forth above, computing devices have been used to promote wellness. However, current systems do not assist a user in developing the set of strategies and best practices for stress reduction and resiliency, which can be achieved, by way of example and not limitation, mindfulness. For example only, mindfulness is the intentional and non judgmental assessment of a person's own, presently-occurring emotions. Practicing cognitive behaviour therapy (CBT) and mindfulness helps a person see more clearly the patterns of his or her own mind in order to, for example, learn how to recognize when the person's mood is becoming or has become negative. A negative mood can be, by way of example and not limitation, anxious, fearful, angry, resentful, and despondent.

Practicing CBT and mindfulness also helps a person recognize whether a negative mood is rational. A negative mood can be irrational in that the mood can be based on inaccurate factual information. A negative mood can also be irrational in that the mood can be based on incomplete factual information. A negative mood can also be irrational in that the mood can be based on illogical conclusions drawn from factual information. A negative mood can also be irrational in that the mood can be based on any combination of inaccurate information, incomplete information, and illogical conclusion(s).

Practicing CBT and mindfulness can allow a person to consciously identify and reject an irrational basis of a negative mood. The person can thus also more-easily pursue or retain a positive mood. CBT and mindfulness also helps a person take more pleasure in positive conditions that often go unnoticed or unappreciated.

CBT and mindfulness is a mental skill analogous to speaking a different language or solving mathematical problems. Such skills require instruction and practice to obtain and maintain. Current wellness systems are not configured to provide such a tool.

The present disclosure provides a method for assisting a user in practicing CBT and mindfulness. The method can be performed by a CBT and mindfulness training tool executed on a computing device. For example only, a user may speak or enter text into a computing device and the computing device can compare the information provided by the user to data stored in memory. The information provided by the user can represent factual information and conclusions drawn from at least some of the factual information. The data stored in memory can be impugning material that is selected from memory based on the factual information and the conclusion received from the user. The impugning material can be audio and/or visual information and contradicts the conclusion of the user. The impugning material is configured to be consistent with all of the factual information provided by the user. In some embodiments, a CBT and mindfulness training tool can be a self-development tool and can be configured to indicate how well the user is practicing CBT and mindfulness. The tool can indicate a numerical improvement and also specify areas that the user's practice of CBT and mindfulness can be improved.

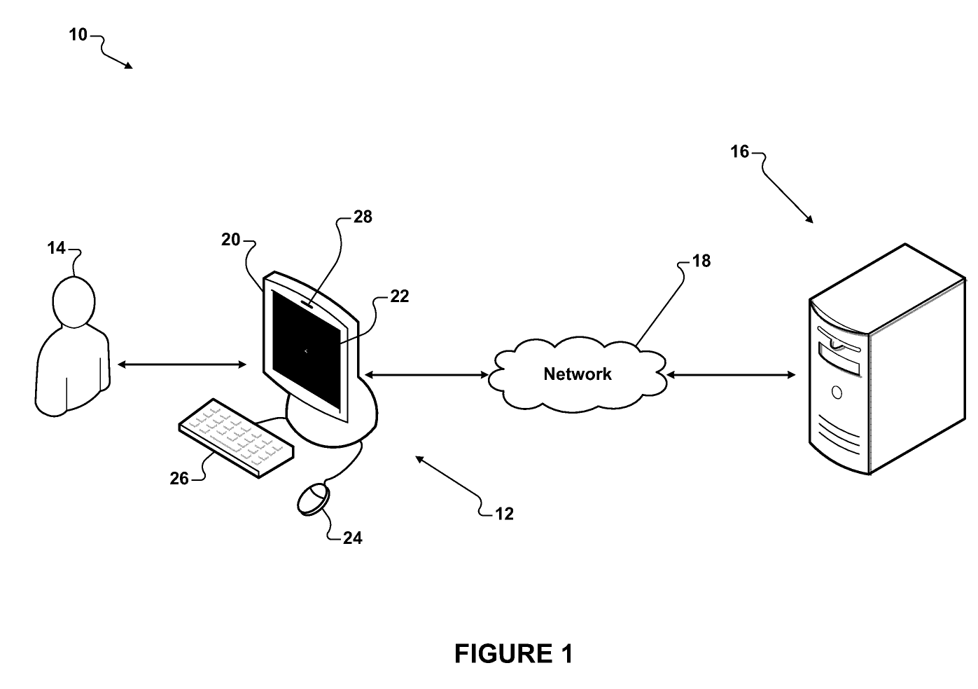

Referring now to FIG. 1, a diagram of an example computing system 10 is illustrated. The computing system 10 can include a computing device 12 that is operated by a user 14. The computing device 12 can be configured to communicate with a computing device 16 via a network 18. Examples of the computing device 12 include desktop computers, laptop computers, tablet computers, and mobile phones. In some embodiments, the computing device 12 can be a mobile computing device associated with the user 14. In some embodiments, the computing device 16 can be a server, wherein input from the user 14 is received by the computing device 16 through the computing device 12 associated directly with the user 14. The network 18 can include a local area network (LAN), a wide area network (WAN), e.g., the Internet, or a combination thereof.

In some implementations, the computing device 12 includes peripheral components. The computing device 12 can include a display 20 having display area 22. In some implementations, the display 20 is a touch display. The computing device 12 can also include other input devices, such as a mouse 24, a keyboard 26, and a microphone 28.

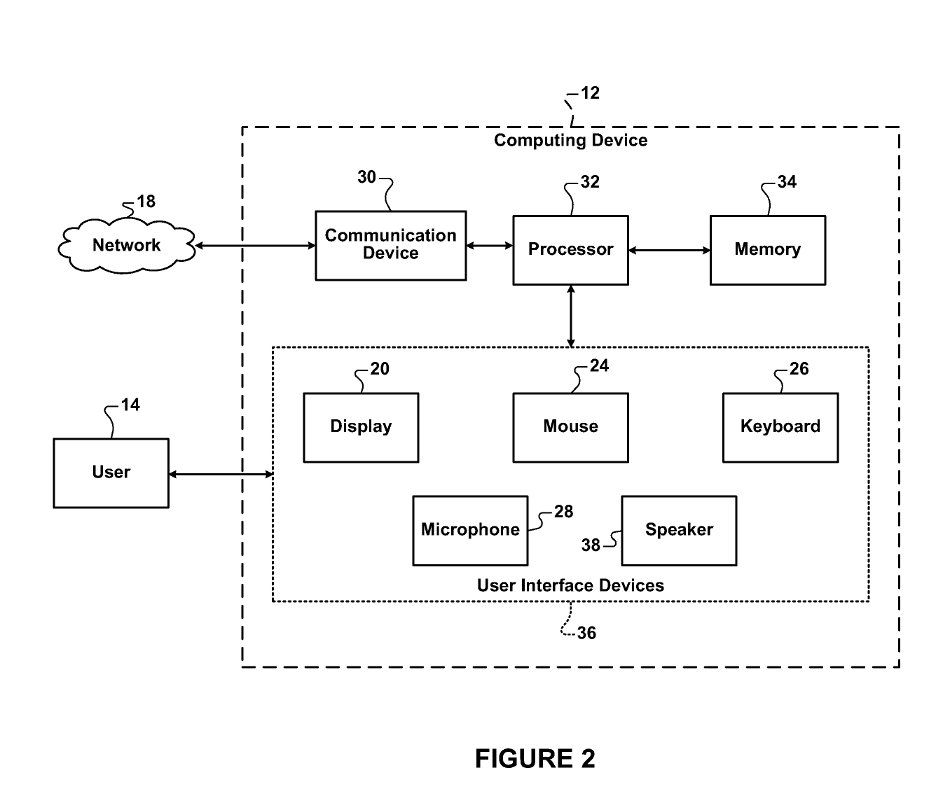

A functional block diagram of the computing device 12 is illustrated as FIG. 2. While a single computing device 12 and its associated user 14 and example components are described and referred to hereinafter, it should be appreciated that both computing devices 12, 16 can have the same or similar configuration and thus can operate in the same or similar manner. Further, the computing devices 12 and 16 can cooperatively define a computing device according to the present disclosure. The computing device 12 can include a communication device 30, a processor 32, and a memory 34. The computing device 12 can also include the display 20, the mouse 24, the keyboard 26, and the microphone 28 (referred to herein individually and collectively as “user interface devices 36”). The user interface devices 36 are configured for interaction with the user 14. In some implementations, the user interface devices 212 can further include a speaker 38.

The communication device 30 is configured for communication between the processor 32 and other devices, e.g., the other computing device 16, via the network 18. The communication device 30 can include any suitable communication components, such as a transceiver. Specifically, the communication device 30 can transmit a voice input and/or a text input from the user 14 to the computing device 16 for processing and can provide a response to this request to the processor 32. The communication device 30 can then handle transmission and receipt of the various communications between the computing devices 12, 16 during CBT and mindfulness training by the user 14 in some embodiments of the present disclosure. The memory 34 can be configured to store information at the computing device 12, such as text files representative of facts and one or more possible conclusions associated with the facts and files representative of training materials for the user 14 to become proficient in practicing CBT and mindfulness. The training material can include at least one of audio and visual information configured to increase the proficiency of the user 14 in the skill of CBT and mindfulness when utilized by the user 14. The memory 34 can be any suitable storage medium (flash, hard disk, etc.).

The processor 32 can be configured to control operation of the computing device 12. It should be appreciated that the term “processor” as used herein can refer to both a single processor and two or more processors operating in a parallel or distributed architecture. The processor 32 can be configured to perform general functions including, but not limited to, loading/executing an operating system of the computing device 12, controlling communication via the communication device 30, and controlling read/write operations at the memory 34. The processor 32 can also be configured to perform specific functions relating to at least a portion of the present disclosure including, but not limited to, loading/executing an CBT and mindfulness training tool at the computing device 12, initiating/controlling CBT and mindfulness training, and controlling the display 20, including creating and modifying a user interface of the CBT and mindfulness training tool, which is described in greater detail below.

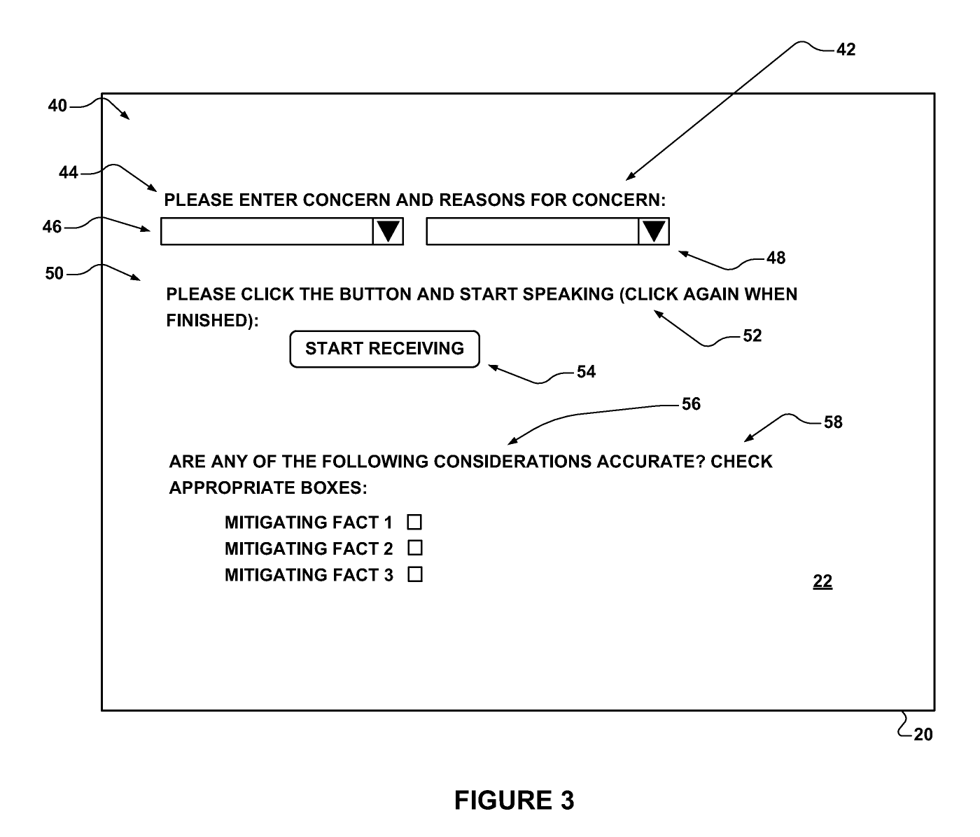

Referring now to FIG. 3, a diagram of the display 20 of an example computing device 12 is illustrated. The computing device 12 can load and execute a CBT and mindfulness training application 40, which is illustrated by a user interface displayed in the display area 22 of the display 20. The CBT and mindfulness training application 40 may not occupy the entire display area 22, e.g., due to toolbars or other borders (not shown). The CBT and mindfulness training application 40 can be configured to initiate a CBT and mindfulness evaluation and training session, which includes displaying prompts to the user 14.

The CBT and mindfulness training application 40 can control the display 20 to display a first prompt 42 in the form of text 44 and pull down menus 46, 48. The first prompt 42 can solicit a first input from the user 14 indicative of or representing a description of a cognitive condition of the user. The cognitive condition can correspond to stress experienced by the user 14. The pull down menu 46 can present the user with a plurality of different conclusions to choose from. Each conclusion can reflect a negative mood and source of stress of the user 14. For example, one of the conclusions can be “an important project for work is due soon and I will be terminated if it is not done well.” The first input can also include factual information the user 14 associates with the conclusion, such as project for work is due soon. The pull down menu 48 can present the user with a plurality of different facts to choose from. The pull down menu 48 can allow the user 14 to associate one or more facts with the conclusion; the user 14 believes the facts selected in the pull down menu 48 evidence the conclusion selected in the pull down menu 46. By way of example and not limitation, the selectable facts presented to the user 14 can be “my boss is short-tempered,” “I have not done well in previous projects,” and “my boss does not like me.” The selections made in the pull down menus 46, 48 can define the first input. When the user 14 makes selections pull down menus 46, 48, the selections can be automatically transmitted to the computing device 12.

The CBT and mindfulness training application 40 can control the display 20 to also display a second prompt 50 in the form of text 52 and a button 54. The text 52 can communicate an instruction to the user 14 to transmit a voice input as the first input to the computing device 12. The voice input can include at least one speech sound generated by the user 14. The at least one speech sound can be representative of one or more words describing the conclusion and the facts supporting the conclusion. The user 14 can select the button 54 and begin speaking into the microphone 28 of the computing device 12. The user 14 can again select the button 54 when finished speaking. The computing device 12 can receive the voice input by the user 14 speaking into the microphone 28. The computing device 12 can include voice-recognition software to determine the words spoken by the user 14.

After receiving the first input, the computing device 12 can search memory 34 based on the conclusion and can identify additional factual information to present to the user 14a, such as mitigating facts. Mitigating facts associated with the conclusion selected by the user 14 can be stored in memory 34. Memory 34 can contain facts associated with the conclusion that are not presented in the pull down menu 48.

Continuing the example started above, the user 14 has selected the conclusion “an important project for work is due soon and I will be terminated if it is not done well” and the facts “my boss is short-tempered,” “I have not done well in previous projects,” and “my boss does not like me.” Memory 34 can contain other facts (“mitigating facts”) associated with the conclusion “an important project for work is due soon and I will be terminated if it is not done well” such as “the boss has not terminated others for not doing well on similar projects in the past,” “I am on schedule to complete the project in time,” and “I have conducted research in every possible area.” After receiving the first input and obtaining the mitigating facts, the application 40 can present the mitigating facts to the user 14. The CBT and mindfulness training application 40 can control the display 20 to also display a third prompt 56 with text 58 and display the mitigating facts below the prompt 56. The CBT and mindfulness training application 40 can allow the user 14 to confirm which mitigating facts are relevant by displaying boxes that can be checked by the user 14.

The mitigating facts selected by the user 14 define a second input received by the computing device 12. It is noted that mitigating facts can also be presented to the user 14 as sound files and confirmed by the voice of the user 14. Thus, the second input includes factual information inconsistent with the at least one conclusion.

The CBT and mindfulness training application 40 can also determine impugning material based on the first and second inputs. The impugning material can be configured to contradict the at least one conclusion and be consistent with the factual information of the first input and the factual information of the second input. The CBT and mindfulness training application 40 can output the impugning material to the user 14 as audio and/or visual information. The impugning material can be a conclusion that is alternative to the conclusion held by the user 14. The facts input by the user 14 and the mitigating facts selected by the user 14 can support (be consistent with) the impugning material.

The CBT and mindfulness training application 40 can associate, in memory, particular examples of impugning material with the facts that were presented to the user 14 in pull down menu 48 as well as the mitigating facts. Continuing the example started above, the user 14 has selected the conclusion “an important project for work is due soon and I will be terminated if it is not done well” and the facts “my boss is short-tempered,” “I have not done well in previous projects,” and “my boss does not like me.” The user 14 can also have selected mitigating facts “the boss has not terminated others for not doing well on similar projects in the past” and “I have conducted research in every possible area.” A particular impugning material associated with the conclusion selected by the user 14 and the facts can be “it is not likely you will be terminated even if the project is not perfect.” This impugning material can be stored in memory 34 and can be obtained by the computing device 12 in response to the user 14 selecting the conclusion “an important project for work is due soon and I will be terminated if it is not done well;” the facts “my boss is short-tempered,” “I have not done well in previous projects,” and “my boss does not like me;” and the mitigating facts “the boss has not terminated others for not doing well on similar projects in the past” and “I have conducted research in every possible area.” The impugning material thus presents an alternative, more rational, and more positive thought for the user 14. The user 14 can learn to develop his or her own impugning material by repeated use of the application 40.

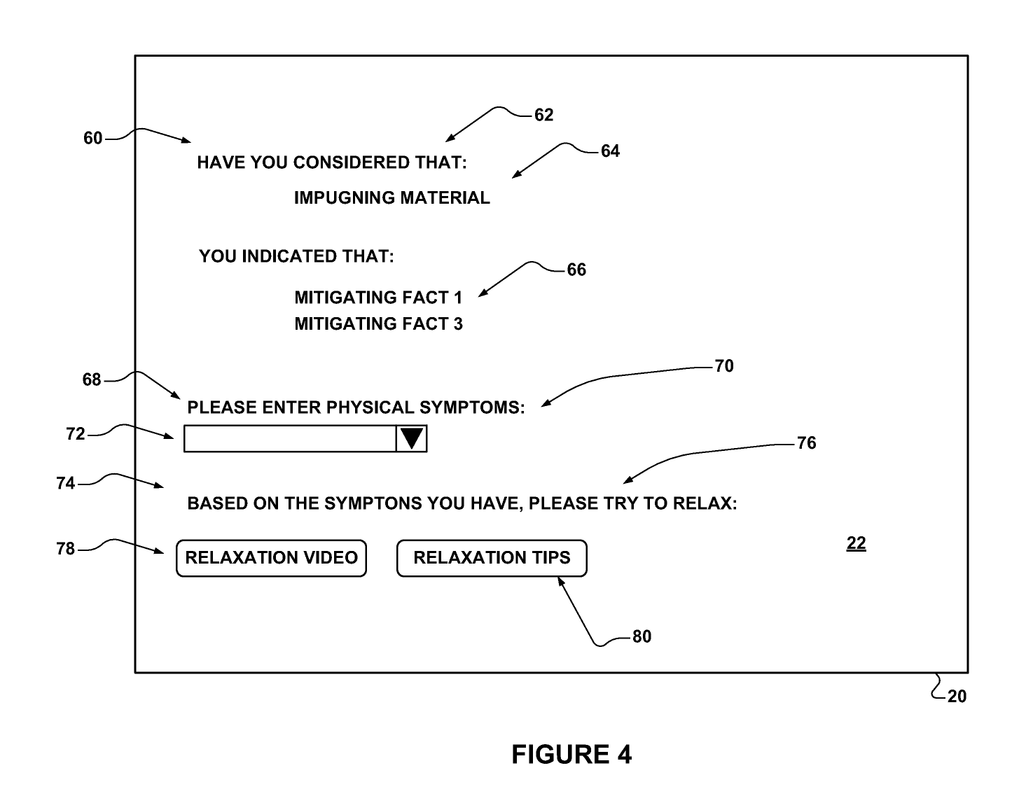

Referring now to FIG. 4, the CBT and mindfulness training application 40 can control the display 20 to display a prompt 60 in the form of text 62 after obtaining the impugning material. The CBT and mindfulness training application 40 can control the display 20 to display the impugning material at 64. For example, at 64 the CBT and mindfulness training application 40 can control the display 20 to display “it is not likely you will be terminated even if the project is not perfect.” The CBT and mindfulness training application 40 can also control the display 20 to display the mitigating facts (at 66) which are consistent with the impugning material 64 and not consistent with the conclusion selected by the user 14 in the pull down menu 46.

The CBT and mindfulness training application 40 can control the display 20 to output the impugning material to the user in a plurality of different formats. The impugning material 64 can be displayed more than one time on the display 22 or in a font different than the other text that is displayed. The impugning material 64 can be displayed in more than one color on the display 22. The impugning material 64 can be displayed more than on time on the display 22 in a pulsing pattern. The option of varying the display of the impugning material 64 facilitates the adoption of the impugning material 64 to replace the conclusion originally-held by the user 14. The original, negative conclusion is to be replaced with the more realistic impugning material 64.

To further facilitate the reduction in stress, the CBT and mindfulness training application 40 can output training material to the user 14. The CBT and mindfulness training application 40 can control the display 20 to display a prompt 68 in the form of text 70 and a pull down menu 72. The prompt 68 can solicit information from the user 14 indicative of or representing at least one physical symptom of the user 14. The pull down menu 72 can present the user 14 with a plurality of different symptoms to choose from and can allow the user 14 to select one or more symptoms.

The computing device 12 can determine appropriate physical training stored in memory 34 in response to the selections made by the user 14 in the pull down menu 72. The training material can be audio and/or visual information configured to reduce the physical symptoms of the user 14. The computing device 12 can output the training material to the user 14 through the user interface. The CBT and mindfulness training application 40 can control the display 20 to display a prompt 74 having text 76 and buttons 78, 80. In response to the user 14 selecting button 78, the CBT and mindfulness training application 40 can control the display 20 to display a video of soothing images such as guided imagery. In response to the user 14 selecting button 78, the CBT and mindfulness training application 40 can control the display 20 to display one or more textual descriptions of relaxation techniques. In some embodiments, the CBT and mindfulness training application 40 can control the speaker 38 to emit relaxing music.

The plurality of conclusions presented to the user 14 in the pull down menu 56, facts presented to the user 14 in pull down menu 58, the mitigating facts presented to the user 14, and the impugning material 64 can be discrete items of data or files indexed in memory with respect to one another. The engagement of the user 14 with the system trains the user 14 with the steps that can be taken to master CBT and mindfulness.

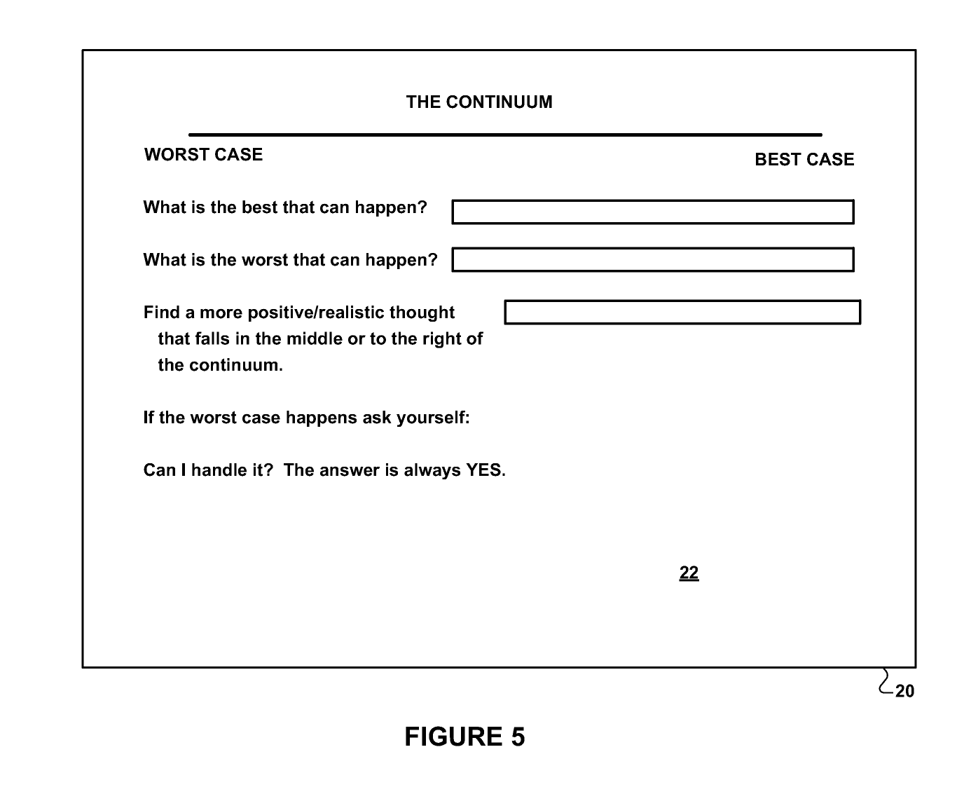

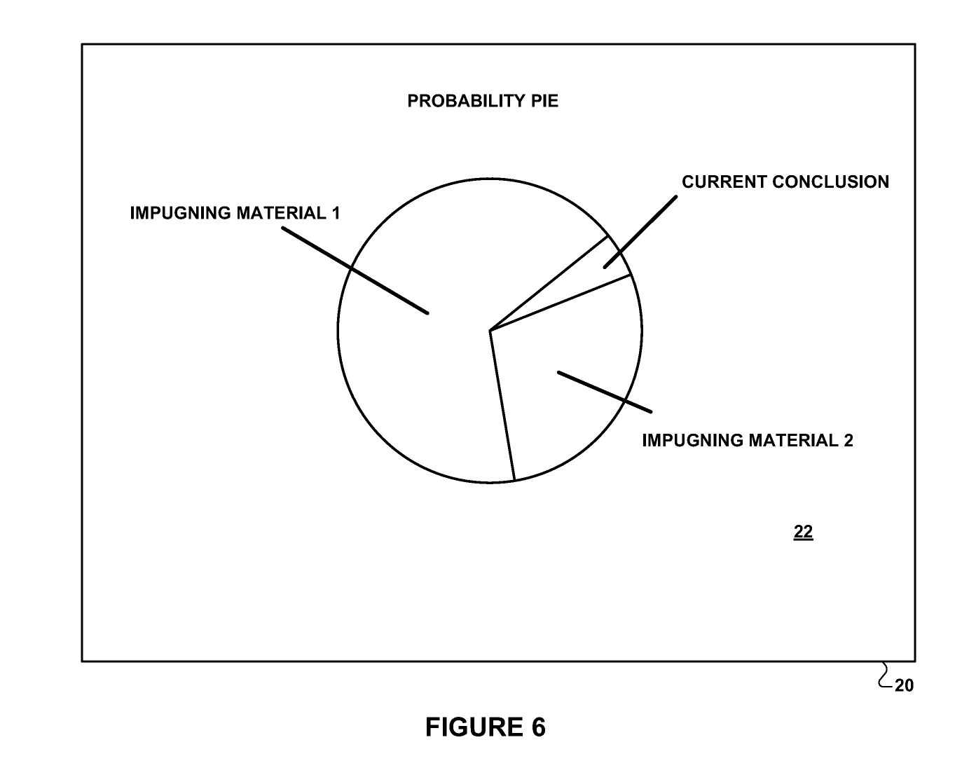

Referring now to FIGS. 5 and 6, some embodiments of the present disclosure can provide additional tools for the user 14 to develop proficiency at the skill of CBT and mindfulness. As illustrated in FIG. 5, the CBT and mindfulness training application 40 can control the display 20 to display a series of questions to the user 14. The series of questions are configured to prompt the user 14 to input conclusions alternative to a currently-held negative conclusion and, possibly, alternative to a previously-provided impugning material. The questions guide the user 14 in developing a continuum of possible conclusions. This exercise is CBT and mindfulness training. As illustrated in FIG. 6, the CBT and mindfulness training application 40 can control the display 20 to display a probability pie or continuum tool to the user 14. The probability pie or continuum tool can indicate the probabilities of at least the at least one conclusion and alternative to the impugning material. The user 14 can select the probability of each possible conclusion and/or the application 40 can propose probabilities for each possible conclusion.

Seven measures of CBT and mindfulness have been developed. These objective standards of measurement are based on self-reporting of trait-like constructs. These standards of measurement are the Mindful Attention Awareness Scale (MAAS), the Freiburg Mindfulness Inventory (FMI), the Kentucky Inventory of Mindfulness Skills (KIMS), the Cognitive and Affective Mindfulness Scale (CAMS), the Mindfulness Questionnaire (MQ), the Revised Cognitive and Affective Mindfulness Scale (CAMS-R), and the Philadelphia Mindfulness Scale (PHLMS). One or more embodiments of the present disclosure can track the progress of the user 14 in CBT and mindfulness proficiency. The user 14 can be tested using any of these measures and retested after one or more interactions with the CBT and mindfulness training application 40. Scores from the tests can be displayed to the user 14 so that the user 14 can monitor his or her progress.

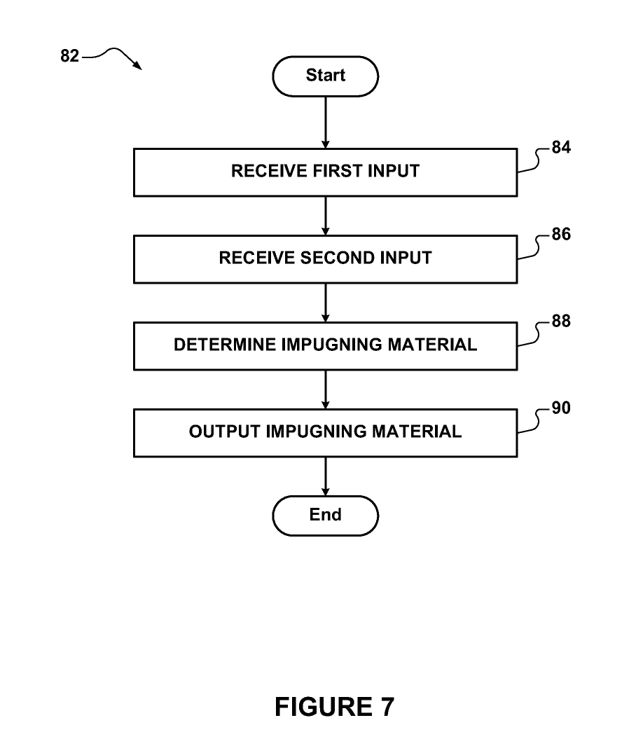

Referring now to FIG. 7, a flow diagram of an example method 82 for assisting a user 14 in developing CBT and mindfulness proficiency with the CBT and mindfulness training application 40 is illustrated. For ease of description, the method 82 will be described in reference to being performed by a computing device 12, but it should be appreciated that the method 82 can be performed by two or more computing devices operating in a parallel or distributed architecture, and/or any one or more particular components of one or a plurality of computing devices.

At 84, the computing device 12 can receive a first input from the user 14. As mentioned above, the first input can include at least one of text and speech and represent a description of cognitive conditions of the user 14. The cognitive conditions correspond to stress experienced by the user 14. The first input includes factual information and at least one conclusion drawn by the user 14 from the factual information.

At 86, the computing device 12 can receive a second input from the user 14. The second input can include at least one of text and speech. The second input includes factual information inconsistent with the at least one conclusion.

At 88, the computing device 12 can determine impugning material based on the factual information and the at least one conclusion of the first input. The impugning material can include at least one of audio and visual information and be configured to contradict the at least one conclusion. The impugning material can be configured to be consistent with the factual information of the first input and the factual information of the second input. At 90, the computing device 12 can output the impugning material to the user 14.

It is noted that one or more embodiments of the present disclosure can perform operations in addition to the operations detailed above. For example, a CBT and mindfulness training application can allow the user to access videos and text explaining CBT and mindfulness techniques to decrease stress. This information can indicate to the user 14 the utility of providing the first and second input set forth above. Embodiments of the present disclosure can teach a user a set of skills/strategies that can be applied daily. Such skills/strategies can be applied across the lifespan for nearly any problem. CBT and mindfulness techniques have been proven to support mental and physical health and contribute to a more healthy life.

CBT strategies can be applied in the workplace, which in turn can be transferred to home and community life. A user will benefit globally from becoming proficient at applying such strategies. The basic principle of CBT is to understand that the way we think affects how we feel emotionally and physically, and that influences our behavior. These relationships are illustrated by the cognitive triangle. Individuals have their own, individual response to a particular event. The key to CBT is to identify the most troubling thoughts, feelings and behaviors related to the particular event.

CBT helps people to understand their problems as well as offering techniques which enable people to learn to make changes. This leads to an improvement in emotional symptoms and empowers people to live fulfilling lives according to their own values and needs. An individual's reaction to an event is not viewed as being right or wrong per se. However, the way people react to events can often bring upon poor mental health and lead to a vicious cycle. For example, if someone feels depressed, they react by withdrawing from others, which only worsens their mood further. By identifying whether these thoughts are helpful or unhelpful in achieving specific work and life goals, people can make choices about how to respond to different circumstances.

It is noted that one or more embodiments of the present disclosure can require that the user 14 pass a test covering CBT before proceeding beyond an initial informative portion of the embodiment.

It is noted that one or more embodiments of the present disclosure can also provide information to the user on stress and how the human body reacts to stress. Stress is a state of mental tension and worry caused by problems in work and relationships, for example. There are many things that can cause stress such as financial troubles, job issues, loss of a loved one, illness, daily demands, and deadlines. Psychological resilience is defined as an individuals' ability to adapt to stress and adversity. Resiliency is demonstrated within individuals who can effectively and relatively easily navigate their way around crisis and utilize effective methods of coping.

Stress can produce various symptoms such as headache, flushing, dizziness, sweating, shaking (can be whole body or legs, arms), freezing (become paralyzed), increased heart rate, faster breathing, difficulty breathing/short of breath, numb, sense of doom, stomach pains, butterflies, nausea, vomiting, diarrhea, goose bumps, dry mouth, shaky voice, and stuttering.

It is noted that one or more embodiments of the present disclosure can require that the user 14 pass a test covering the nature and symptoms of stress before proceeding beyond a second informative portion of the embodiment.

It is noted that one or more embodiments of the present disclosure can provide a third informative portion to the user on common thought distortions. Thought distortions are ways that the mind convinces an individual of something that is not true. These inaccurate thoughts are usually used to reinforce negative thinking or bad emotions. They tell us things that sound rational and accurate, but really only serve to keep an individual feeling stressed, anxious or self-doubting. All-or-nothing thinking is an example of a thought distortion. An individual views things in black and white categories. If your performance falls short of perfect, you see yourself as a total failure. Over-generalization is another example of a thought distortion. An individual views a single negative event as a never-ending pattern of defeat. Mental filtering is another example of a thought distortion. An individual dwells on negative details exclusively so that the vision of all reality becomes darkened. Disqualifying positives is another example of a thought distortion. An individual rejects positive experiences by insisting they “don't count” for some reason or other. The person maintains a negative belief that is contradicted by everyday experiences. Jumping to conclusions is another example of a thought distortion. Mind reading is another example of a thought distortion. Anticipating that things will turn out badly and feel convinced that your prediction is an already-established fact is another example of a thought distortion. Magnification or minimization is another example of a thought distortion. An individual exaggerates the importance of things (such as a mistake up or someone else's achievement), or inappropriately trivializes facts. Emotional reasoning is another example of a thought distortion. An individual assumes negative emotions necessarily reflect the way things really are. “Should statements” is another example of a thought distortion. An individual tries to motivate himself or herself with “should” and “should not” statements, as if punishment is the only motivation to act. Labeling and mislabeling is another example of a thought distortion and is an extreme form of overgeneralization. Instead of describing your error, the individual attaches a negative label to himself or herself Personalization is another example of a thought distortion. An individual views himself or herself as the cause of some negative external event for which, in fact, he or she was not responsible.

It is noted that one or more embodiments of the present disclosure can require that the user 14 pass a test covering thought distortions before proceeding beyond the third informative portion of the embodiment.

It is noted that one or more embodiments of the present disclosure can provide a fourth informative portion to the user on strategies for physically coping with stress. Coping strategies such as deep breathing can be presented in videos. Facts associated with deep breathing can be presented in pop-ups as the user is inputting data or reviewing output. Relaxation techniques reduce stress symptoms and improve quality of life. Practicing relaxation techniques can reduce symptoms by slowing heart rate, lowering blood pressure, slowing breathing rate, reducing the activity of stress hormones, increasing blood flow to major muscle groups, reducing muscle tension and chronic pain, improving concentration and mood, lowering fatigue-reducing anger and frustration, and boosting in confidence to handle problems.

Videos explain relaxation techniques can detail proper deep breathing exercises, progressive muscle relaxation, and display guided imagery. Video and/or textual information can be displayed to the user that enhances the likelihood of positive daily tips and lifestyle choices. These tips can include sleep and eating well, exercising, journaling, playing an instrument, and/or cooking.

It is noted that one or more embodiments of the present disclosure can require that the user 14 pass a test covering strategies for physically coping with stress before proceeding beyond the fourth informative portion of the embodiment.

It is noted that one or more embodiments of the present disclosure can provide a fifth informative portion to the user on follow-up support and maintenance. The user can be encouraged to use an embodiment repeatedly to extract the most value. The user's activity can be recorded and displayed to the user. Helpful tips and updates can be communicated to the user on a regular basis, such as to an email account.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

It is noted that an organization providing an embodiment of the present disclosure to its employees can have at least two champions and/or two champions for every 100 employees. Such champions can receive supplemental training. The supplemental training can be three or more hours and can be accomplished via webcast, or live training. The training can help the champion learn how CBT and mindfulness work in more depth and how to ensure that the concept of the exemplary embodiment stays alive within their organization. This will include how to discuss principles of the exemplary embodiment in team meetings etc. The champions will have their own log-in on a website of a provider of an exemplary embodiment. Tips and updates for using an exemplary embodiment can be posted monthly. The champions can also call the provider for support when and if needed (non-emergent/urgent support).

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A computer-implemented method, comprising:
receiving, at a computing device having one or more processors, a first input from a user, the first input including at least one of text and one or more speech sounds representative of one or more words, the first input representing a description of cognitive conditions of the user, the cognitive conditions corresponding to stress experienced by the user, and the first input including factual information and at least one conclusion drawn by the user from the factual information;
receiving, at the computing device, a second input from the user after receiving the first input, the second input including at least one of text and one or more speech sounds representative of one or more words, the second input including factual information inconsistent with the at least one conclusion;
determining, at the computing device, impugning material based on the factual information and the at least one conclusion of the first input, the impugning material including at least one of audio and visual information configured to contradict the at least one conclusion, the impugning material configured to be consistent with the factual information of the first input and the factual information of the second input; and
outputting, at the computing device, the impugning material to the user.

2. The computer-implemented method of claim 1 wherein said outputting is further defined as:
outputting, at the computing device, the impugning material to the user a plurality of different formats.

3. The computer-implemented method of claim 1 wherein said outputting is further defined as:
outputting, at the computing device, the impugning material to the user in a pulsing pattern.

4. The computer-implemented method of claim 1 wherein the factual information of the first input includes physical symptoms of the user.

5. The computer-implemented method of claim 4 further comprising:
determining, at the computing device, training material based on the physical symptoms, the training material including at least one of audio and visual information configured to reduce the physical symptoms of the user; and
outputting, at the computing device, the training material to the user.

6. The computer-implemented method of claim 1 further comprising:
outputting, at the computing device, a series of questions to the user, the series of questions configured to prompt the user to input conclusions alternative to the at least one conclusion and alternative to the impugning material.

7. The computer-implemented method of claim 1 further comprising:
outputting, at the computing device, a display of a probability pie to the user, the probability pie indicating the probabilities of at least the at least one conclusion and alternative to the impugning material.

8. A computing device, comprising:
one or more processors; and
a non-transitory, computer readable medium storing instructions that, when executed by the one or more processors, cause the computing device to perform operations comprising:
receiving a first input from a user, the first input including at least one of text and one or more speech sounds representative of one or more words, the first input representing a description of cognitive conditions of the user, the cognitive conditions corresponding to stress experienced by the user, and the first input including factual information and at least one conclusion drawn by the user from the factual information;
receiving a second input from the user after receiving the first input, the second input including at least one of text and one or more speech sounds representative of one or more words, the second input including factual information inconsistent with the at least one conclusion;
determining impugning material based on the factual information and the at least one conclusion of the first input, the impugning material including at least one of audio and visual information configured to contradict the at least one conclusion, the impugning material configured to be consistent with the factual information of the first input and the factual information of the second input; and
outputting the impugning material to the user.

9. The computing device of claim 8 wherein said outputting is further defined as:
outputting, at the computing device, the impugning material to the user a plurality of different formats.

10. The computing device of claim 8 wherein said outputting is further defined as:
outputting, at the computing device, the impugning material to the user in a pulsing pattern.

11. The computing device of claim 8 wherein the factual information of the first input includes physical symptoms of the user.

12. The computer-implemented method of claim 11 wherein the instructions stored on the non-transitory, computer readable medium, when executed by the one or more processors, further cause the computing device to perform the operations:
determining, at the computing device, training material based on the physical symptoms, the training material including at least one of audio and visual information configured to reduce the physical symptoms of the user; and
outputting, at the computing device, the training material to the user.

13. The computing device of claim 8 wherein the instructions stored on the non-transitory, computer readable medium, when executed by the one or more processors, further cause the computing device to perform the operation:
outputting, at the computing device, a series of questions to the user, the series of questions configured to prompt the user to input conclusions alternative to the at least one conclusion and alternative to the impugning material.

14. The computing device of claim 8 wherein the instructions stored on the non-transitory, computer readable medium, when executed by the one or more processors, further cause the computing device to perform the operation:
outputting, at the computing device, a display of a probability pie to the user, the probability pie indicating the probabilities of at least the at least one conclusion and alternative to the impugning material.

15. A computer program product comprising a non-transitory, computer readable storage medium having computer-readable instructions embodied in the medium that when executed by a computing device having one or more processors cause the computing device to perform operations comprising:
receiving a first input from a user, the first input including at least one of text and one or more speech sounds representative of one or more words, the first input representing a description of cognitive conditions of the user, the cognitive conditions corresponding to stress experienced by the user, and the first input including factual information and at least one conclusion drawn by the user from the factual information;
receiving a second input from the user after receiving the first input, the second input including at least one of text and one or more speech sounds representative of one or more words, the second input including factual information inconsistent with the at least one conclusion;
determining impugning material based on the factual information and the at least one conclusion of the first input, the impugning material including at least one of audio and visual information configured to contradict the at least one conclusion, the impugning material configured to be consistent with the factual information of the first input and the factual information of the second input; and
outputting the impugning material to the user.

16. The computer program product of claim 15 wherein said outputting is further defined as:
outputting, at the computing device, the impugning material to the user a plurality of different formats.

17. The computer program product of claim 15 wherein said outputting is further defined as:
outputting, at the computing device, the impugning material to the user in a pulsing pattern.

18. The computer program product of claim 15 wherein the factual information of the first input includes physical symptoms of the user.

19. The computer-implemented method of claim 18 wherein the instructions stored on the non-transitory, computer readable medium, when executed by the one or more processors, further cause the computing device to perform the operations:
determining, at the computing device, training material based on the physical symptoms, the training material including at least one of audio and visual information configured to reduce the physical symptoms of the user; and
outputting, at the computing device, the training material to the user.

20. The computer program product of claim 15 wherein the instructions stored on the non-transitory, computer readable medium, when executed by the one or more processors, further cause the computing device to perform the operation:
outputting, at the computing device, a series of questions to the user, the series of questions configured to prompt the user to input conclusions alternative to the at least one conclusion and alternative to the impugning material.
